(19) United States
(12) Patent Application Publication
(10) Pub. No.: US 2026/0005465 A1
(43) Pub. Date: Jan. 1, 2026

(54) CONNECTOR

(71) Applicant: YOKOWO CO., LTD., Tokyo (JP)

(72) Inventor: Kenta TAKAHASHI, Gunma (JP)

(73) Assignee: YOKOWO CO., LTD., Tokyo (JP)

(21) Appl. No.: 19/112,279

(22) PCT Filed: Sep. 13, 2023
(86) PCT No.: PCT/JP2023/033303

§ 371 Date: Mar. 17, 2025

(30) Foreign Application Priority Data
Sep. 20, 2022 (JP) 2022-149042

(51) Int. Cl. H01R 13/52; H01R 13/415

(52) U.S. Cl. CPC H01R 13/5216; H01R 13/415; H01R 13/521; H01R 13/5213

(57) ABSTRACT

A connector includes: a housing having an opening; a terminal accommodated in the housing; a plurality of lid bodies configured to close the opening; and a covering material configured to cover, from an outside of the housing, the opening closed by the plurality of lid bodies. The terminal passes between the plurality of lid bodies, penetrates the covering material, and extends toward the outside of the housing.

### TECHNICAL FIELD

The present invention relates to a connector.

### BACKGROUND ART

The following Patent Literature 1 discloses a connector having a structure in which a terminal is accommodated in a housing.

### CITATION LIST

### Patent Literature

Patent Literature 1: JP 5501143 B

### SUMMARY OF INVENTION

### Technical Problem

The connector disclosed in Patent Literature 1 does not take waterproofing into consideration, and water that seeps into the housing reaches the mounting board of the connector through the lower opening of the housing.

An example of the object of the present invention is to provide a connector having a good waterproofing property. Other objects of the present invention will become apparent based on the present description.

### Solution to Problem

An aspect of the present invention provides a connector including:
a housing having an opening;
a terminal accommodated in the housing;
a plurality of lid bodies configured to close the opening; and
a covering material configured to cover, from an outside of the housing, the opening closed by the plurality of lid bodies,
in which the terminal passes between the plurality of lid bodies, penetrates the covering material, and extends toward the outside of the housing.

An aspect of the present invention provides a method for manufacturing a connector, the method including:
inserting a terminal into a housing having an opening through the opening of the housing, and placing the terminal in a state in which the terminal protrudes from the opening;
assembling a plurality of elastic bodies to the opening to close the opening and to sandwich a part of the terminal; and
filling the opening that is closed by the plurality of elastic bodies with a covering material to cover the opening from an outside of the housing.

According to the above aspects of the present invention, it is possible to provide a connector having a good waterproofing property.

### BRIEF DESCRIPTION OF DRAWINGS

FIG. 1 is a perspective view of a connector 1 according to an embodiment of the present invention, as viewed from the upper front right side.

FIG. 2 is a perspective view of the connector 1 as viewed from the lower rear right side.

FIG. 3 is a plan view of the connector 1.

FIG. 4 is a front view of the connector 1.

FIG. 5 is a right side view of the connector 1.

FIG. 6 is a bottom view of the connector 1 in which a sealing material 90 is omitted.

FIG. 7 is a cross-sectional view taken along a line VII-VII in FIG. 4.

FIG. 8 is a cross-sectional view taken along a line VIII-VIII in FIG. 6.

FIG. 9 is a perspective view of the connector 1 as viewed from the lower front left side, and is a perspective view in which the housing 10 is cut along a line IX-IX in FIG. 6 and a first lid body 50 is omitted.

FIG. 10 is a perspective view in which one terminal 30 is separated in FIG. 9.

FIG. 11 is a partially exploded perspective view of the connector 1, as viewed from the upper front right side.

FIG. 12 is a partially exploded perspective view of the connector 1 in which the sealing material 90 is omitted, as viewed from the lower rear left side.

FIG. 13 is an enlarged cross-sectional view of a part of FIG. 8.

FIG. 14 is a cross-sectional view in which the terminal 30 in FIG. 13 is replaced with a terminal 130 according to a comparative example.

FIG. 15 is an enlarged view of a part of FIG. 9.

FIG. 16 is a view in which the terminal 30 in FIG. 15 is replaced with the terminal 130 according to the comparative example.

### DESCRIPTION OF EMBODIMENTS

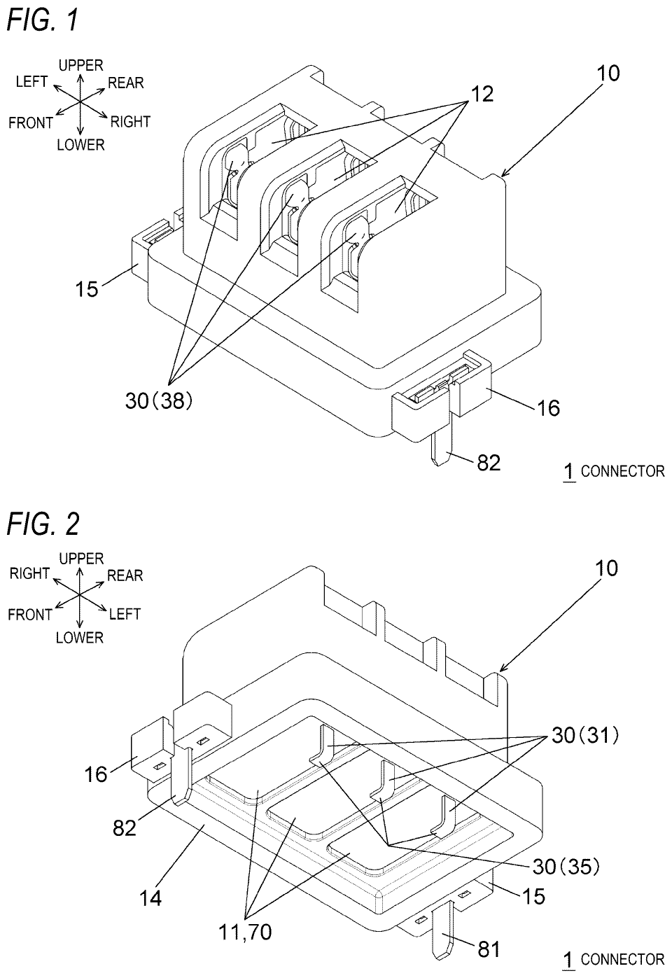

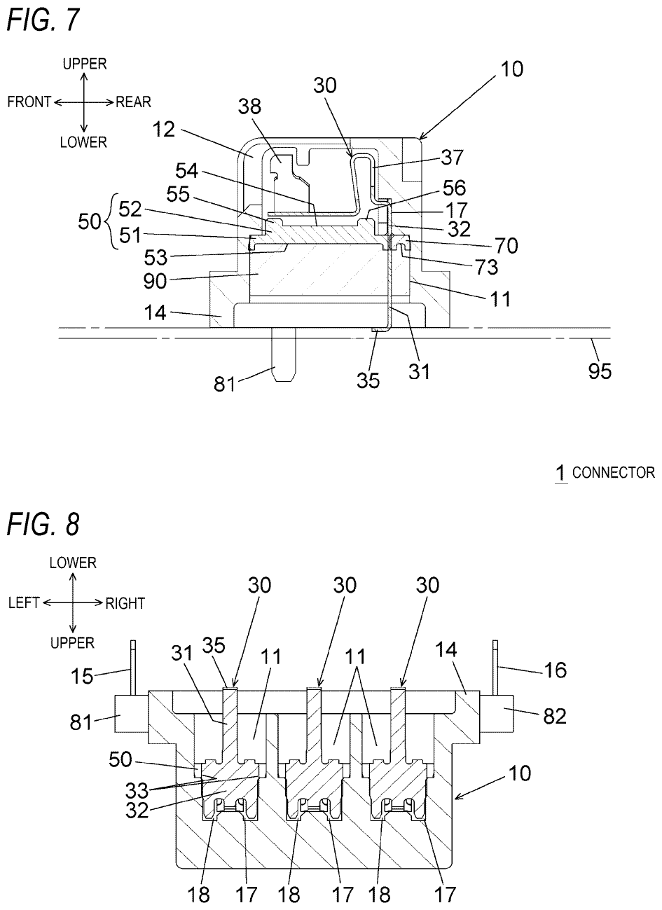

The present embodiment relates to a connector 1 used for electrical connection. FIG. 1 defines the front-rear direction, the upper-lower direction, and the left-right direction of the connector 1 that are orthogonal to one another. The front-rear direction and the left-right direction are parallel to a board 95 (FIG. 7) on which the connector 1 is to be mounted. The upper-lower direction is a direction that is perpendicular to the board 95. The left-right direction is, when a plurality of terminals 30 are provided, the arrangement direction of the terminals 30. In the present description, the surface of each element facing forward is referred to as a “front surface” and the surface facing rearward is referred to as a “back surface”.

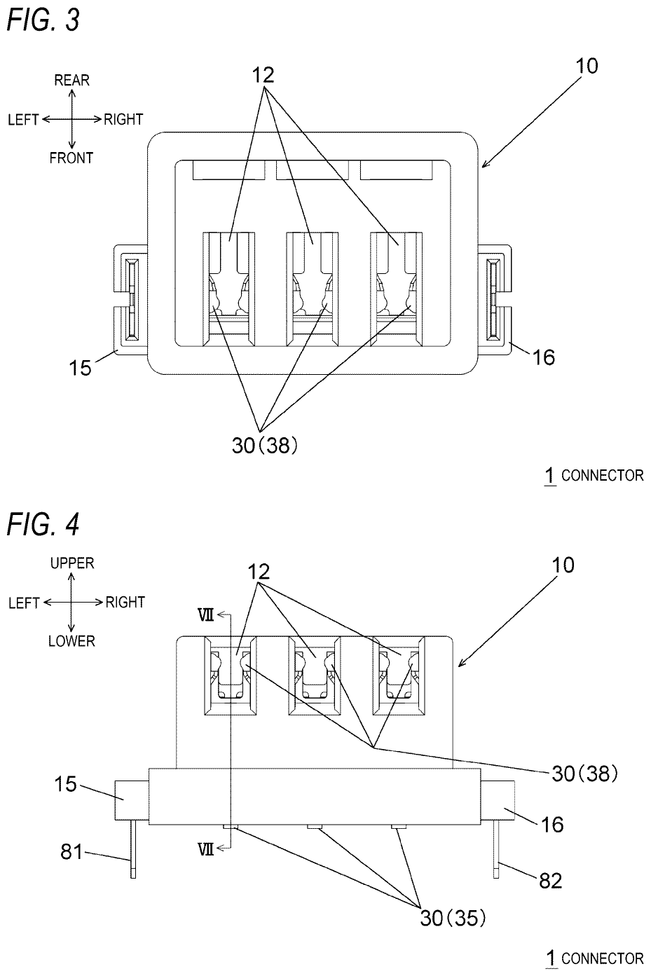

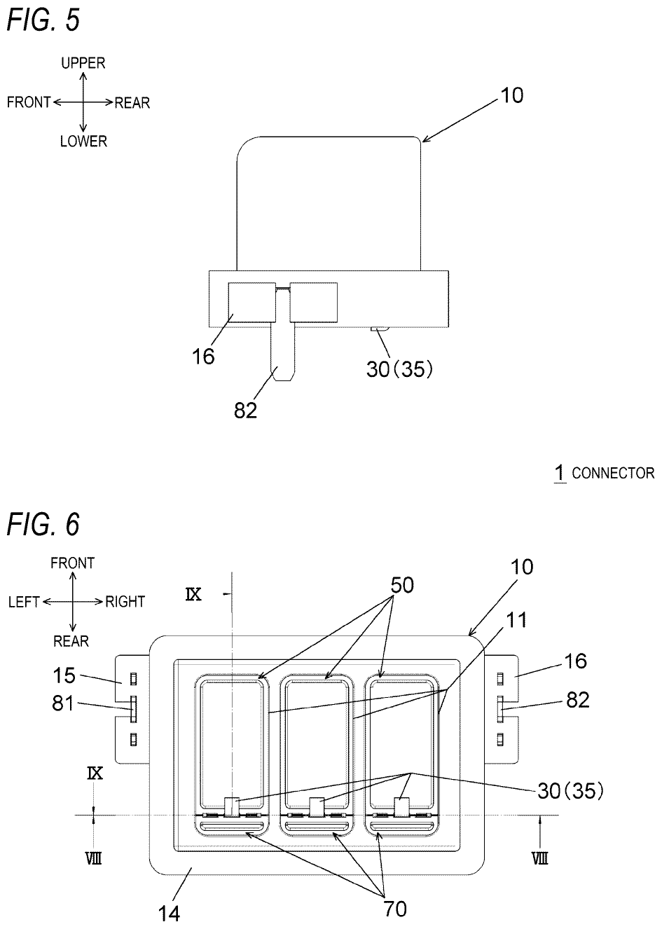

FIGS. 1 to 6 show an overall structure of a connector 1. FIG. 7 shows a side cross-sectional view of the connector 1. The connector 1 includes an insulating housing 10, the conductive terminal 30, a first lid body 50, a second lid body 70, and a sealing material 90 serving as a covering material. In the present embodiment, as an example, three terminals 30, three first lid bodies 50, and three second lid bodies 70 are provided, and the number of each is not limited to three.

The housing 10 is, for example, a resin molded body, and accommodates and holds the three terminals 30. The housing 10 has three first openings 11 that open to insert the terminals 30 into the inside of the housing 10, and three second openings 12 that open to expose the terminals 30 to the outside of the housing 10. The number of the first openings 11 and the second openings 12 is not limited to three, and is appropriately set depending on the number of terminals 30.

As shown in FIG. 2 and the like, the three first openings 11 are formed in the lower surface of the housing 10 and aligned in the left-right direction. As shown in FIG. 1 and the like, the three second openings 12 are aligned in the left-right direction across the front surface and the upper surface of the housing 10.

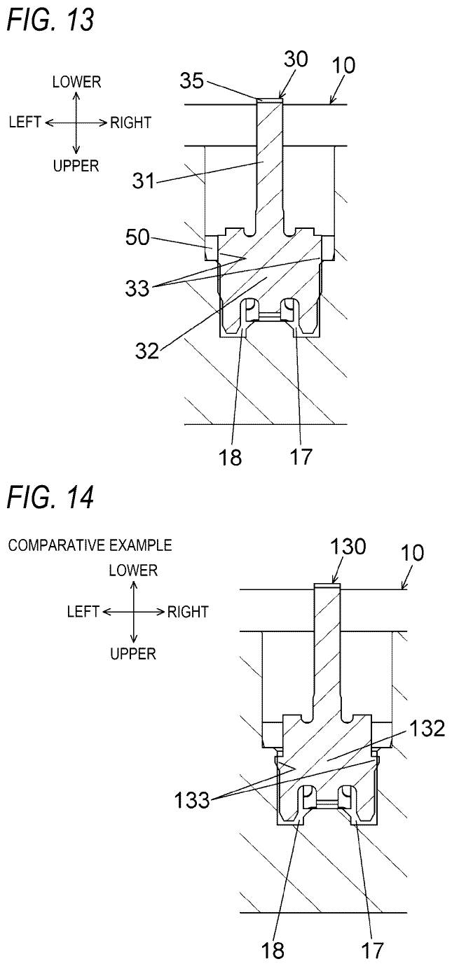

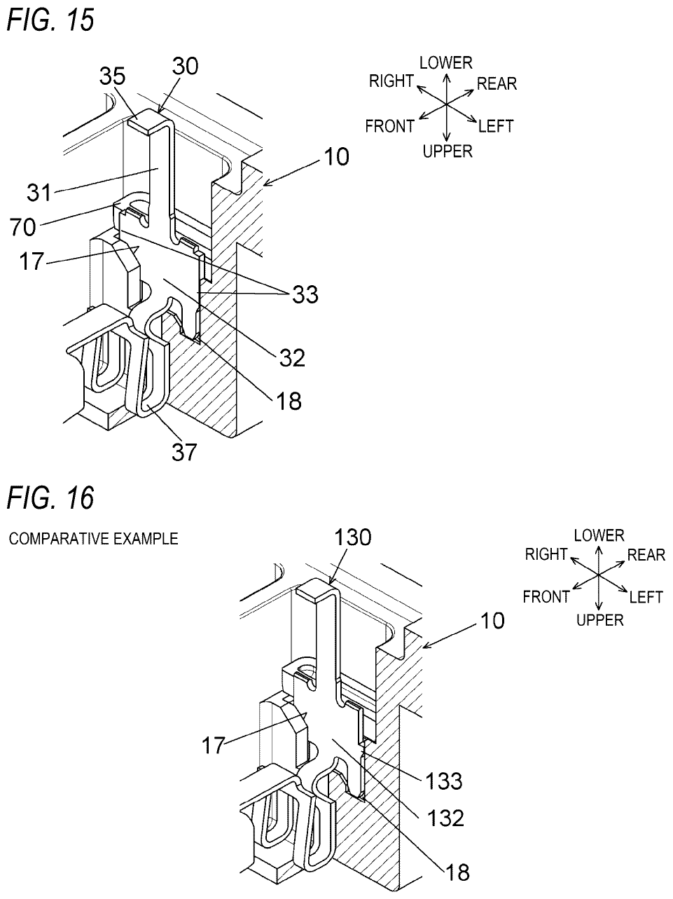

As shown in FIGS. 8, 10, 13 and 15, the housing 10 has grooves 17 and 18 for holding held portions 32 of the terminals 30. The grooves 17 and 18 are formed above the rear portions of the first openings 11 and extend in the upper-lower direction.

The grooves 17 and 18 are located on the inner side of the housing 10 with respect to the first lid body 50 and the second lid body 70. The first lid body 50 and the second lid body 70 will be described in detail later. The lower end portions of the grooves 17 and 18, that is, the end portions on the first lid body 50 and second lid body 70 side are entrances for inserting the held portion 32 from below and open downward. The right portion of the held portion 32 is inserted into the groove 17 and held therein. The left portion of the held portion 32 is inserted into the groove 18 and held therein. The entrances of the grooves 17 and 18 are closed by the held portion 32, the first lid body 50, and the second lid body 70 to such an extent that the uncured sealing material 90 cannot seep therein.

As shown in FIG. 2 and the like, the housing 10 includes a surrounding portion 14. The surrounding portion 14 is a convex portion that is located at the outer peripheral portion of the lower end of the housing 10 and that extends in a substantially rectangular shape, and protrudes downward so as to surround the front, rear, left, and right of the lower end portions of the three first openings 11.

As shown in FIG. 2 and the like, the housing 10 includes holding portions 15 and 16 that hold mounting portions 81 and 82 on both left and right side surfaces. The mounting portions 81 and 82 are sheet metal components that are formed by, for example, pressing a plate-shaped metal. The mounting portions 81 and 82 are connected by soldering or the like to the board 95 (FIG. 7) on which the connector 1 is to be mounted, and fix the housing 10 to the board 95.

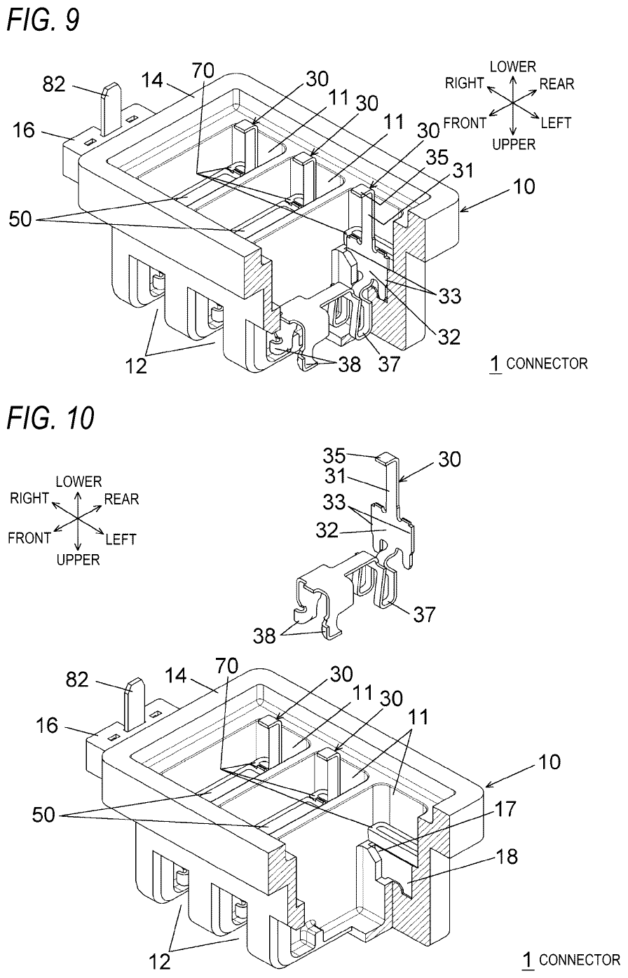

The terminal 30 is made of a metal material such as beryllium copper or titanium copper, and is a sheet metal component formed by pressing a plate-shaped metal. The terminal 30 may be formed by molding or cutting. The terminal 30 may be subjected to surface plating processing. In the present embodiment, as shown in FIGS. 7 and 9 to 12, the terminal 30 includes a leg portion 31, the held portion 32, a surface mounting portion 35, a plate spring portion 37, and a contact portion 38.

The leg portion 31 is a flat plate-shaped portion that is substantially perpendicular to the front-rear direction and extends parallel to the upper-lower direction. The leg portion 31 passes between the first lid body 50 and the second lid body 70, penetrates the sealing material 90, and extends downward from the first opening 11 toward the outside of the housing 10.

The surface mounting portion 35 is a portion that is bent for surface mounting below the sealing material 90, that is, on the outer side of the housing 10. In the present embodiment, the surface mounting portion 35 is a flat plate-shaped portion that is substantially perpendicular to the upper-lower direction, and is bent from the lower end portion of the leg portion 31 and extends forward. Other examples include an example in which the surface mounting portion 35 is bent from the lower end portion of the leg portion 31 and extends rearward, an example in which the surface mounting portion 35 extends in the left-right direction, and an example in which the surface mounting portion 35 is divided into two portions. The surface mounting portion 35 is electrically connected by soldering or the like to a conductive pattern (not shown) on the board 95 (FIG. 7) on which the connector 1 is to be mounted, and the connector 1 is surface mounted.

As shown in FIG. 8, the held portion 32 is a flat plate-shaped portion that is substantially perpendicular to the front-rear direction and is continuous with the upper portion of the leg portion 31. The held portion 32 is fitted (for example, press-fitted) into the grooves 17 and 18 of the housing 10, and is held in the grooves 17 and 18. The held portion 32 is sandwiched between the first lid body 50 and the second lid body 70 and has a shape extending into the grooves 17 and 18.

The structure in which the held portion 32 is held in the grooves 17 and 18 in the present embodiment will be described. The held portion 32 includes protrusions 33 at both left and right end portions. The protrusion 33 is a protruding portion that bites into the left and right inner surfaces of the grooves 17 and 18 and that generates a holding force in the left-right direction. However, the holding structure is not limited to this form. Regarding the holding of the terminal 30 on the housing 10, a holding method by adhesion may be used instead of or in addition to the holding force provided by the protrusions 33.

As is apparent with reference to FIGS. 8 to 10, 13 and 15, the protrusion 33 passes downward through the entrances of the grooves 17 and 18 and extends to between the first lid body 50 and the second lid body 70. The protrusion 33 may protrude downward from the first lid body 50 and the second lid body 70.

The plate spring portion 37 has a substantially inverted U shape when viewed from the side, and is continuous with the upper portion of the held portion 32. The plate spring portion 37 acts to give the contact portion 38 appropriate flexibility. The contact portion 38 is supported on the plate spring portion 37, and is exposed to the outside of the housing 10 from the second opening 12. The contact portion 38 is divided into two parts on the left and right, between which a terminal (for example, a plug) of a mating connector (not shown) is inserted and electrically connected.

As shown in FIGS. 7, 9, and 12, the first lid body 50 and the second lid body 70 close the first opening 11. Further, the held portion 32 and the protrusion 33 of the terminal 30 are located between the first lid body 50 and the second lid body 70. The first lid body 50 and the second lid body 70 are elastic bodies such as silicone rubber, and the side peripheral portion (for example, the side peripheral surface) thereof is pressed against the inner peripheral portion (for example, the inner peripheral surface) of the first opening 11 and fitted into the first opening 11 by the own elastic forces of the first lid body 50 and the second lid body 70, and is held on the housing 10 in a state of closing the first opening 11.

The first lid body 50 closes the front portion of the first opening 11 from the held portion 32 of the terminal 30. The back surface of the first lid body 50 comes into elastic contact with the front surface of the held portion 32. The second lid body 70 closes the rear portion of the first opening 11 from the held portion 32. The front surface of the second lid body 70 comes into elastic contact with the back surface of the held portion 32. That is, the first lid body 50 and the second lid body 70 close the first opening 11 and sandwich the held portion 32 from the front-rear direction.

As shown in FIGS. 7, 11, and 12, the lid body 50 includes a first portion 51 and a second portion 52. The first portion 51 is a lower portion of the first lid body 50 and is fitted into the first opening 11. The second portion 52 is the upper portion of the first lid body 50 and protrudes upward from the upper surface of the first portion 51. The second portion 52 is smaller in dimension in the front-rear direction than the first portion 51. The second portion 52 protrudes from the first opening 11 into the space in the housing 10.

The first lid body 50 includes an inclined portion 63 on the side peripheral portion of the first portion 51 excluding the back surface portion. The inclined portion 63 is an inclined surface that widens from above to below. The first lid body 50 includes a surrounding portion 64. The surrounding portion 64 is a convex portion that is located at the outer peripheral portion of the lower surface of the first lid body 50 and that extends in a substantially rectangular shape. The first lid body 50 has a recess 53 (or a hollow portion) on the lower surface, that is, the surface facing the outside of the housing 10. The recess 53 is surrounded by the surrounding portion 64 on the front, rear, left and right sides.

When the side peripheral portion of the surrounding portion 64 excluding the back surface portion is fitted into the first opening 11, the side peripheral portion is pressed against the inner peripheral portion of the first opening 11 and elastically deforms, and generates a holding force for the first opening 11. When the holding force is generated, the recess 53 is present, so that the surrounding portion 64 can elastically deform and escape into the recess 53, and the bending of the first lid body 50 in the upper-lower direction is prevented.

The first lid body 50 has a recess 54 on the upper surface, that is, the surface facing the inside of the housing 10. The first lid body 50 includes protrusions 55 and 56 at the edge portions of the recess 54 in the front-rear direction. The recess 54 prevents the first lid body 50 from interfering with the terminal 30 or preventing elastic deformation of the terminal 30 when the first lid body 50 is bent upward. The protrusions 55 and 56 prevent excessive deformation of the terminal 30.

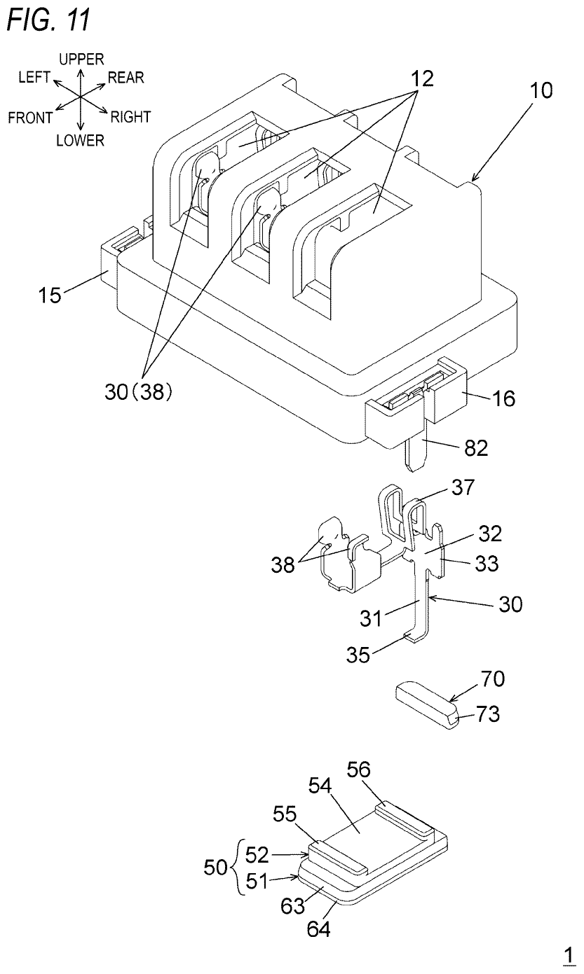

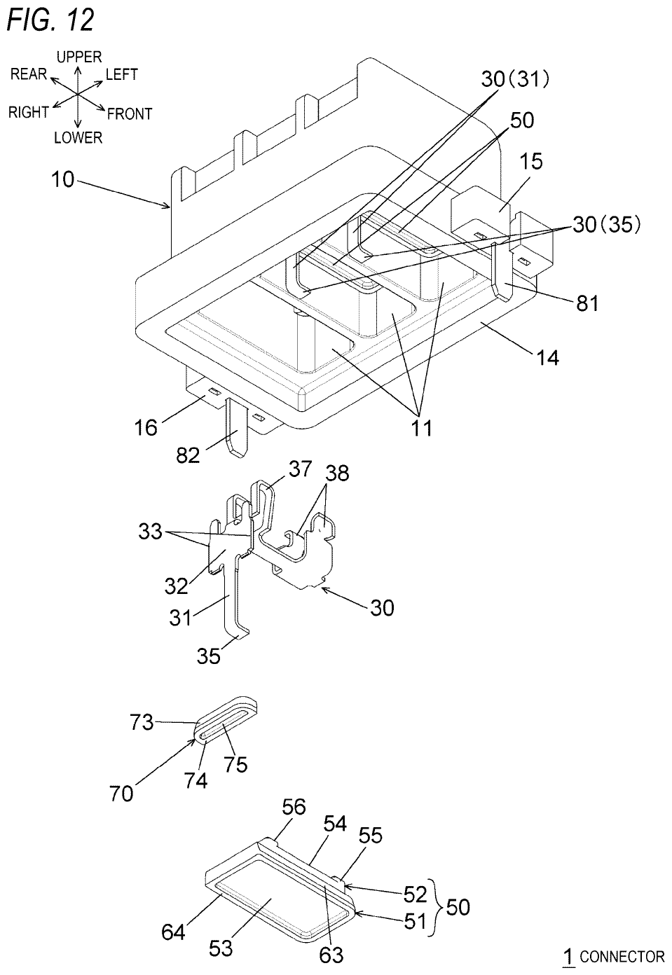

As shown in FIGS. 11 and 12, the second lid body 70 includes an inclined portion 73 on the side peripheral portion excluding the front surface portion. The inclined portion 73 is an inclined surface that widens from above to below. The second lid body 70 includes a surrounding portion 74. The surrounding portion 74 is a convex portion that is located at the outer peripheral portion of the lower surface of the second lid body 70 and that extends in a substantially rectangular shape. The second lid body 70 has a recess 75 (or a hollow portion) on the lower surface, that is, the surface facing the outside of the housing 10. The recess 75 is surrounded by the surrounding portion 74 on the front, rear, left and right sides.

When the side peripheral portion of the surrounding portion 74 excluding the front surface portion is fitted into the first opening 11, the side peripheral portion is pressed against the inner peripheral portion of the first opening 11 and elastically deforms, and generates a holding force for the first opening 11. At this time, the recess 75 is present, so that the surrounding portion 74 can elastically deform and escape into the recess 75, and the bending of the second lid body 70 in the upper-lower direction is prevented.

The sealing material 90 is a material such as urethane resin or epoxy resin, and covers the first opening 11 that is closed by the first lid body 50 and the second lid body 70 from the outside of the housing 10. The sealing material 90 may fill up to a depth that exceeds the first opening 11 and that touches the inner peripheral portion of the surrounding portion 14.

A method for manufacturing the connector 1 is as follows, for example.

As shown in FIG. 10 and the like, the terminal 30 is inserted into the housing 10 through the first opening 11 of the housing 10, the contact portion 38 of the terminal 30 is exposed to the outside of the housing 10 through the second opening 12, and the leg portion 31 of the terminal 30 protrudes from the first opening 11. Subsequently, the first lid body 50 and the second lid body 70 are assembled so as to close the first opening 11 and to sandwich the held portion 32 of the terminal 30. Subsequently, a potting process is performed. Specifically, the uncured sealing material 90 fills the first opening 11 that is closed by the first lid body 50 and the second lid body 70 so as to cover the first opening 11 from the outside (the lower side in the drawing) of the housing 10. Thereafter, the sealing material 90 is cured. Examples of the curing method include thermal curing and curing by mixing two liquids.

The present embodiment has the following effects.
(1) Since the first opening 11 of the housing 10 is closed by the first lid body 50 and the second lid body 70 and further covered with the sealing material 90, the water that seeps into the housing 10 through the second opening 12 can be prevented from leaking out through the first opening 11 to the outside. Therefore, the waterproof property of the connector 1 can be improved. In addition, the waterproof property can be ensured while securing the movable range of the mating connector.
(2) The leg portion 31 of the terminal 30 passes between the first lid body 50 and the second lid body 70, penetrates the sealing material 90, and extends downward from the first opening 11 toward the outside of the housing 10. Therefore, even if the surface mounting portion 35 is provided assuming surface mounting on the board, there are no problems in assembly, and it is possible to easily cope with surface mounting on various boards. If the first opening 11 is to be closed with a single lid body, the leg portion 31 of the terminal 30 needs to penetrate the lid body, and the presence of the surface mounting portion 35 makes it difficult to penetrate the lid body, resulting in a poor assembly property. According to the present embodiment, such a problem can be solved suitably.
(3) The back surface of the first lid body 50 comes into elastic contact with the front surface of the held portion 32. Therefore, in the potting process, it is possible to prevent the uncured sealing material 90 from seeping into the inside of the housing 10 from between the back surface of the first lid body 50 and the front surface of the held portion 32. Similarly, the front surface of the second lid body 70 comes into elastic contact with the back surface of the held portion 32. Therefore, in the potting process, it is possible to prevent the uncured sealing material 90 from seeping into the inside of the housing 10 from between the front surface of the second lid body 70 and the back surface of the held portion 32.
(4) The protrusion 33 of the held portion 32 of the terminal 30 passes downward through the entrances of the grooves 17 and 18 and extends to between the first lid body 50 and the second lid body 70. Therefore, even if the uncured sealing material 90 seeps between the first lid body 50 and the second lid body 70 in the potting process, the uncured sealing material 90 cannot pass through the press-fit portions of the protrusion 33 and the grooves 17 and 18. Therefore, the uncured sealing material 90 that seeps between the first lid body 50 and the second lid body 70 can be prevented from seeping into the inside of the housing 10. For comparison, a case will be considered in which a protrusion 133 is present only above the entrances of the grooves 17 and 18, as in the terminal 130 according to a comparative example shown in FIGS. 14 and 16. In this case, as shown in FIG. 14, the uncured sealing material 90 is likely to seep into the inside of the housing 10 through the gap between the right surface of the held portion 132 located below the protrusion 133 and the inner surface of the groove 17 facing the right surface. Similarly, the uncured sealing material 90 is likely to seep into the inside of the housing 10 through the gap between the left surface of the held portion 132 located below the protrusion 133 and the inner surface of the groove 18 facing the left surface. According to the present embodiment, such seeping of the uncured sealing material 90 can be suitably prevented.
(5) The first lid body 50 and the second lid body 70 are elastic bodies, and are fitted into the first opening 11 by the own elastic forces thereof and held in the first opening 11. Therefore, it is not necessary to press the first lid body 50 and the second lid body 70 from below, and it is easy to use a configuration in which the leg portion 31 of the terminal 30 protrudes downward from the first lid body 50 and the second lid body 70 while preventing an increase in the number of components and cost. When the first lid body 50 and the second lid body 70 are not elastic bodies, it is necessary to assemble a sheet metal component or the like from below the lid body to the housing and to press the first lid body 50 and the second lid body 70. In the case of a configuration in which the sheet metal component is assembled to the housing 10, it is difficult to use a configuration in which the leg portion 31 of the terminal 30 protrudes downward from the first lid body 50 and the second lid body 70 due to the presence of the sheet metal component. In the present embodiment, such a disadvantage can be eliminated.
(6) Since the first lid body 50 and the second lid body 70 are elastic bodies, a gap between the side peripheral portions of the first lid body 50 and the second lid body 70 and the inner peripheral portion of the first opening 11 is less likely to be formed, and the filling range of the sealing material 90 is easily controlled. That is, it is possible to prevent the uncured sealing material 90 from leaking out and adhering to the inside of the housing 10 during the potting process.
(7) Since the recess 53 is formed in the lower surface portion of the first lid body 50, when the side peripheral portion of the surrounding portion 64 is pressed against the inner peripheral portion of the first opening 11 and is elastically deformed, the surrounding portion 64 can escape into the recess 53. Therefore, the bending of the first lid body 50 in the upper-lower direction is prevented. Accordingly, it is possible to prevent the first lid body 50 from bending downward and the filling range of the sealing material 90 from becoming narrow. It is possible to prevent the first lid body 50 from bending upward and interfering with the terminal 30 or hindering elastic deformation of the terminal 30.
(8) Since the recess 75 is formed in the lower surface portion of the second lid body 70, when the side peripheral portion of the surrounding portion 74 is pressed against the inner peripheral portion of the first opening 11 and is elastically deformed, the surrounding portion 74 can escape into the recess 75. Therefore, the bending of the second lid body 70 in the upper-lower direction is prevented. Accordingly, it is possible to prevent the second lid body 70 from bending downward and the filling range of the sealing material 90 from becoming narrow.
(9) Since the recess 54 is formed in the upper surface portion of the first lid body 50, it is possible to prevent the first lid body 50 from interfering with the terminal 30 or hindering elastic deformation of the terminal 30 when the first lid body 50 is bent upward. On the other hand, since the first lid body 50 includes the protrusions 55 and 56 at the front and rear of the recess 54 and the deformable amount of the terminal 30 is restricted by the protrusions 55 and 56, excessive deformation of the terminal 30 can be prevented.

Embodiments and modifications of the present invention have been described above with reference to the drawings, but these embodiments and modifications are examples of the present invention, and various configurations other than those described above can also be used. For example, the number of the first openings 11 and the second openings 12 that are formed in the housing 10 and the number of the terminals 30 are not limited to three, and may be any number. For example, an example has been shown in which there are two lid bodies, which are the first lid body 50 and the second lid body 70, the number of lid bodies is not limited to two and may be any number.

The shapes of the first opening 11 and the first lid body 50 and second lid body 70 covering the first opening 11 can be appropriately changed to match the shape of the terminal 30. The shape of the second opening 12 can be appropriately changed to match the shapes of the terminal 30 and the terminal of the mating connector.

The configurations of the first lid body 50 and the second lid body 70 are not limited to the present embodiment. For example, a configuration in which the second portion 52 is not provided, a configuration in which the protrusions 55 and 56 are not provided, and a configuration in which the recesses 53 and 75 (the hollow portions) are not formed may be used.

According to the present description, a connector according to the following aspects is provided.

### Aspect 1

A connector including:
a housing having an opening;
a terminal accommodated in the housing;
a plurality of lid bodies configured to close the opening; and
covering material configured to cover, from an outside of the housing, the opening closed by the plurality of lid bodies,
in which the terminal passes between the plurality of lid bodies, penetrates the covering material, and extends toward the outside of the housing.

According to the aspect 1, since the opening of the housing is closed by the plurality of lid bodies and further covered with the covering material, the waterproof property is improved.

### Aspect 2

In the connector, the terminal is bent for surface mounting on an outside of the housing with respect to the covering member.

According to the aspect 2, it is possible to easily cope with surface mounting. Since the terminal passes between the plurality of lid bodies, the assembly difficulty is reduced even if there is a bent portion for surface mounting.

### Aspect 3

In the connector,
the terminal includes a held portion,
the housing has a groove into which the held portion is fitted,
the held portion is sandwiched between the plurality of lid bodies and has a shape extending into the groove, and
an entrance of the groove is closed by the held portion and the plurality of lid bodies to such an extent that the covering material in uncured condition cannot seep through the entrance of the groove.

According to the aspect 3, it is possible to prevent the uncured covering material from seeping into the inside of the housing.

### Aspect 4

In the connector, the held portion includes a protrusion that generates a holding force against an inner surface of the groove, and the protrusion is covered with the plurality of lid bodies.

According to the aspect 4, as compared with a case in which the protrusion is not covered with the plurality of lid bodies, it is possible to prevent the uncured covering material from seeping into the inside of the housing.

### Aspect 5

In the connector, the plurality of lid bodies are elastic bodies, and side peripheral portions of the lid bodies are pressed against an inner peripheral portion of the opening by own elastic forces of the lid bodies and sandwich the held portion.

According to the aspect 5, a configuration is not necessary in which the plurality of lid bodies are pressed, and an increase in the number of components and cost can be prevented. The uncured covering material can be prevented from seeping into the inside of the housing from between each of the first and second lid bodies and the held portion.

### Aspect 6

In the connector,
the housing has a second opening, and
the terminal is exposed to the outside of the housing through the second opening.

According to the aspect 6, since the opening of the housing is closed by the plurality of lid bodies and further covered with the covering material, the water that seeps into the housing through the second opening can be prevented from leaking out through the opening to the outside. Therefore, the waterproof property can be improved. In addition, the waterproof property can be ensured while securing the movable range of the mating connector.

### Aspect 7

A method for manufacturing a connector, the method including:
inserting a terminal into a housing having an opening through the opening of the housing, and placing the terminal in a state in which the terminal protrudes from the opening;
assembling a plurality of elastic bodies to the opening to close the opening and to sandwich a part of the terminal; and
filling the opening that is closed by the plurality of elastic bodies with a covering material to cover the opening from an outside of the housing.

According to the aspect 7, since the opening of the housing is closed by the plurality of lid bodies and further covered with the covering material, the waterproof property is improved. Unlike the case in which the opening is closed with a single elastic body, it is not necessary to allow the terminal to penetrate the elastic body, it is possible to cope with terminals of various shapes, and the assembly property is good.

### REFERENCE SIGNS LIST

1: connector
10: housing
11: first opening
12: second opening
17, 18: groove
30: terminal
32: held portion
35: surface mounting portion
50: first lid body
70: second lid body
90: sealing material

1. A connector comprising:
a housing having an opening;
a terminal accommodated in the housing;
a plurality of lid bodies configured to close the opening; and
a covering material configured to cover, from an outside of the housing, the opening closed by the plurality of lid bodies,
wherein the terminal passes between the plurality of lid bodies, penetrates the covering material, and extends toward the outside of the housing.

2. The connector according to claim 1,
wherein the terminal is bent for surface mounting on an outside of the housing with respect to the covering member.

3. The connector according to claim 1,
wherein the terminal includes a held portion,
wherein the housing has a groove into which the held portion is fitted,
wherein the held portion is sandwiched between the plurality of lid bodies and has a shape extending into the groove, and
wherein an entrance of the groove is closed by the held portion and the plurality of lid bodies to such an extent that the covering material in uncured condition cannot seep through the entrance of the groove.

4. The connector according to claim 3,
wherein the held portion includes a protrusion that generates a holding force against an inner surface of the groove, and the protrusion is sandwiched between the plurality of lid bodies.

5. The connector according to claim 3,
wherein the plurality of lid bodies are elastic bodies, and side peripheral portions of the lid bodies are pressed against an inner peripheral portion of the opening by own elastic forces of the lid bodies and sandwich the held portion.

6. The connector according to claim 1,
wherein the housing has a second opening, and
wherein the terminal is exposed to the outside of the housing through the second opening.

7. A method for manufacturing a connector, the method comprising:
inserting a terminal into a housing having an opening through the opening of the housing, and placing the terminal in a state in which the terminal protrudes from the opening;
assembling a plurality of elastic bodies to the opening to close the opening and to sandwich a part of the terminal; and
filling the opening that is closed by the plurality of elastic bodies with a covering material to cover the opening from an outside of the housing.
